(19) United States
(12) Patent Application Publication
(10) Pub. No.: US 2014/0086237 A1
(43) Pub. Date: Mar. 27, 2014

(54) Method for Virtual Multicast Group IDs

(71) Applicant: AVAYA, INC., Basking Ridge, NJ (US)

(72) Inventor: Hamid Assarpour, Arlington, MA (US)

(73) Assignee: AVAYA, INC., Basking Ridge, NJ (US)

(21) Appl. No.: 13/627,694

(22) Filed: Sep. 26, 2012

(51) Int. Cl. H04L 12/66; H04L 12/56

(52) U.S. Cl. 370/355; 370/390

(57) ABSTRACT

Application MGIDs defining virtual groups of output destinations are assigned by applications and appended to packets to specify on a per-application basis how packets associated with the application should be handed by a network element. The application MGIDs are mapped to single system MGID number space prior to being passed to the network element switch fabric. When a packet is passed to the switch fabric, the application MGID header is passed along with the system MGID header, so that the packet that is passed to the switch fabric has both the system MGID as well as the application MGID. The switch fabric only looks at the system MGID when forwarding the packet, however. Each egress node maintains a set of tables, one table for each application, in which the node maintains a list of ports per application MGID. The egress node uses the application MGID to key into the application table to determine a list of ports, at that egress node, to receive the packet.

### CROSS-REFERENCE TO RELATED APPLICATIONS

None.

### BACKGROUND

1. Field

This application relates to network elements and, more particularly, to a method for virtual multicast group IDs.

2. Description of the Related Art

Data communication networks may include various switches, nodes, routers, and other devices coupled to and configured to pass data to one another. These devices will be referred to herein as “network elements”. Data is communicated through the data communication network by passing protocol data units, such as frames, packets, cells, or segments, between the network elements by utilizing one or more communication links. A particular protocol data unit may be handled by multiple network elements and cross multiple communication links as it travels between its source and its destination over the network.

Network elements are designed to handle packets of data efficiently, to minimize the amount of delay associated with transmission of the data on the network. Conventionally, this is implemented by using hardware in a data plane of the network element to forward packets of data, while using software in a control plane of the network element to configure the network element to cooperate with other network elements on the network. For example, a network element may include a routing process, which runs in the control plane, that enables the network element to have a synchronized view of the network topology so that the network element is able to forward packets of data across the network toward their intended destinations. Multiple processes may be running in the control plane to enable the network element to interact with other network elements on the network and forward data packets on the network.

The applications running in the control plane make decisions about how particular types of traffic should be handled by the network element to allow packets of data to be properly forwarded on the network. As these decisions are made, the control plane programs the hardware in the data plane to enable the data plane to be adjusted to properly handle traffic as it is received. The data plane includes ASICs, FPGAs, and other hardware elements designed to receive packets of data, perform lookup operations on specified fields of packet headers, and make forwarding decisions as to how the packet should be transmitted on the network. Lookup operations are typically implemented using tables and registers containing entries populated by the control plane.

When a router receives a packet, it will perform a search in a forwarding table to determine which forwarding rule is to be applied to a packet having the IP address contained in the packet. Within the network element, a switch fabric implements the forwarding rule by causing the packet to be distributed to a set of ports associated with the forwarding rule so that the packet may be forwarded on toward its intended sets of destinations on the network.

One way that a network element may internally keep track of how to implement a forwarding operation is to assign a Multicast Group ID (MGID) to the packet. The MGID is a value that is used internally within the network element, for example by the switch fabric, to switch a packet from an input to a set of outputs. The MGID is generally implemented as a zero-based unsigned integer where each ID represents a single port vector (port bitmap) or represents a list of port vectors. A port vector essentially represents a list of ports, in which each bit represents an output. For example, at layer 2, the MGID typically represents a list of ports. The MGID, in this instance, directly identifies a set of output ports on which the packet should be forwarded. At layer 3, the MGID is a list of port vectors, in which each port vector is itself a list of ports.

There are a finite number of MGIDs available within the network element. Conventionally, the MGIDs were implemented such that particular ranges of MGIDs were assigned to particular applications. For example, a first range of MGIDs may be allocated to layer 2, and another range of MGIDs may be allocated to layer 3. This, however, led to scalability issues. For example, at layer 2, it may be desirable to assign a separate system MGID to each Virtual Local Area Network ID (VID) to allow packets to be switched within the VLAN. Likewise, at layer 3, each SGV (Source, Destination Group, and VLAN) may need to be assigned to a separate system MGID to enable packets to be routed within the VLAN associated with the SGV. Because there are a finite number of MGIDs, this limits the number of L2 VLANs that may be implemented and the number of layer 3 VLANs (SGVs) that may be implemented by the network element. Further, because the MGID space is shared between multiple applications, the control plane needs to manage the MGID space across protocols, which complicates design of the network element from the control perspective.

### SUMMARY OF THE DISCLOSURE

The following Summary, and the Abstract set forth at the end of this application, are provided herein to introduce some concepts discussed in the Detailed Description below. The Summary and Abstract sections are not comprehensive and are not intended to delineate the scope of protectable subject matter which is set forth by the claims presented below.

Application MGIDs defining virtual groups of output destinations are assigned by applications and appended to packets to specify on a per-application basis how packets associated with the application should be handed by a network element. The application MGIDs are mapped to single system MGID number space prior to being passed to the network element switch fabric. When a packet is passed to the switch fabric, the application MGID header is passed along with the system MGID header, so that the packet that is passed to the switch fabric has both the system MGID as well as the application MGID. The switch fabric only looks at the system MGID when forwarding the packet, however. Each egress node maintains a set of tables, one table for each application, in which the node maintains a list of ports per application MGID. The egress node performs a search to determine if there are any ports on the node which are required to receive a copy of the packet, and if so uses the application MGID to key into the application table to determine a list of ports, at that egress node, to receive the packet.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure. In the figures:

FIG. 1 is a functional block diagram of an example network element;

FIG. 2 is a flow chart showing an example process implemented by the network element of FIG. 1 when forwarding a packet;

FIG. 3 shows a process of handling a packet by hardware elements of a network element according to an embodiment;

FIG. 4 is a functional block diagram of several of the hardware elements of the example network element of FIG. 1;

FIGS. 5 and 6 show example sets of system MGIDs;

FIG. 7 shows an example mapping of application MGIDs to system MGIDs; and

FIG. 8 is a functional block diagram of a line card for use in the example network element of FIG. 1.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

According to an embodiment, each application has its own MGID address space. MGIDs associated with applications will be referred to herein as “application MGIDs.” For example, L2, IPV4, IPV6, Shortest Path Bridging (SPB-802.11ah), may each have its own MGID address space and each application individually manages the application MGIDs assigned from its own MGID address space. An application MGID table is maintained, per application, to keep track of application MGIDs allocated by the applications. For example, at L2, an L2 application MGID table may keep track of L2 MGIDs assigned on a per-VID basis. Each of the other applications keeps track of MGIDs assigned by the application in its application specific MGID table. Application MGIDs may be assigned by applications in whatever manner is convenient for that application. Application MGIDs may be implemented as a port vector or as a list of port vectors.

Application MGIDs are mapped to single system MGID number space prior to being passed to the switch fabric. Many mapping functions may be implemented depending on the particular implementation. The mapping causes the set of ports specified by the application MGID to be mapped to a system MGID that guarantees that the switch fabric will forward a copy of the packet to all of the egress nodes specified in the application MGID. Where the application MGID is implemented as a port vector, the application MGID will be mapped to a system MGID that includes all of the ports specified by the port vector. The system MGID may include additional ports, but at a minimum will include all of the ports of specified by the port vector. Where the application MGID is implemented as a list of port vectors, the application MGID will be mapped to a system MGID that includes all of the ports specified by each of the port vectors in the list of port vectors. The system MGID in this mapping thus enables the superset of all ports of all port vectors of the application MGID to receive a copy of the packet. The system MGID may include additional ports as well, since as discussed below egress node pruning is implemented to drop copies of the packet where copies of the packet are forwarded to egress nodes without associated ports.

Since there may be many more application MGIDs than system MGIDs, the mapping function is expected to be a n:1 mapping function. When a packet is passed to the switch fabric, the application MGID header is passed along with the system MGID header, so that the packet that is passed to the switch fabric has both the system MGID as well as the application MGID. The switch fabric only looks at the system MGID when forwarding the packet, however.

The system MGIDs are all implemented as egress node vectors, in which each egress node vector contains a list of egress nodes. The egress nodes may be implemented as line cards, slices of line cards, or other physical hardware entities.

Each egress node maintains a set of tables, one table for each application, in which the node maintains a list of ports per application MGID. The egress node uses the application MGID to key into the application table to determine a list of ports, at that egress node, to receive the packet. In one embodiment, since the system MGIDs may cause copies of the packet to be forwarded to egress nodes with no ports that are required to receive a copy of the packet, the egress nodes also include a per-application pruning table indicating whether the packet should be dropped prior to implementing the application table lookup.

In operation, when a packet is received, an application MGID is selected for the packet from the application MGID table. The application MGID is added to the packet as a header and the application MGID is mapped to a system MGID. Since multiple application MGIDs associated with multiple applications may specify similar sets of output ports, multiple application MGIDs may map to a single system MGID, so that the limited number of system MGIDs no longer presents a scalability problem on the network element.

The system MGID is used by the switch fabric to forward the packet to a set of egress nodes, as specified by the system MGID. When the egress nodes receive the packet, the egress nodes use the application MGID to implement a preliminary lookup in a per-application pruning table to determine whether there are any ports on the node which require a copy of the packet. If so, the egress node will perform a further lookup, within application specific MGID tables maintained by the egress nodes, to determine sets of output ports at the egress nodes that should receive the packet. This allows the egress nodes to do a port lookup per application MGID. Since multiple application MGIDs are mapped to a single system MGID, it is possible that some of the egress nodes specified by the system MGID will have no receivers for the packet. In that case, the egress node will determine from the per-application pruning tables that no ports on the egress node need a copy of the packet and the egress node will simply drop the packet.

In an embodiment, the system MGID assignment and management is controlled by a central entity. The application is unaware that a separate system MGID is being used for fabric transportation, it is only aware of the application MGID and is therefore completed abstracted from the actual fabric transport. Thus, the application is not required to have explicit knowledge of how a packet is required to be transported across the fabric, but rather simply implements MGID management based on its requirements without regard to how the application MGIDs are later transported across the switch fabric of the network element.

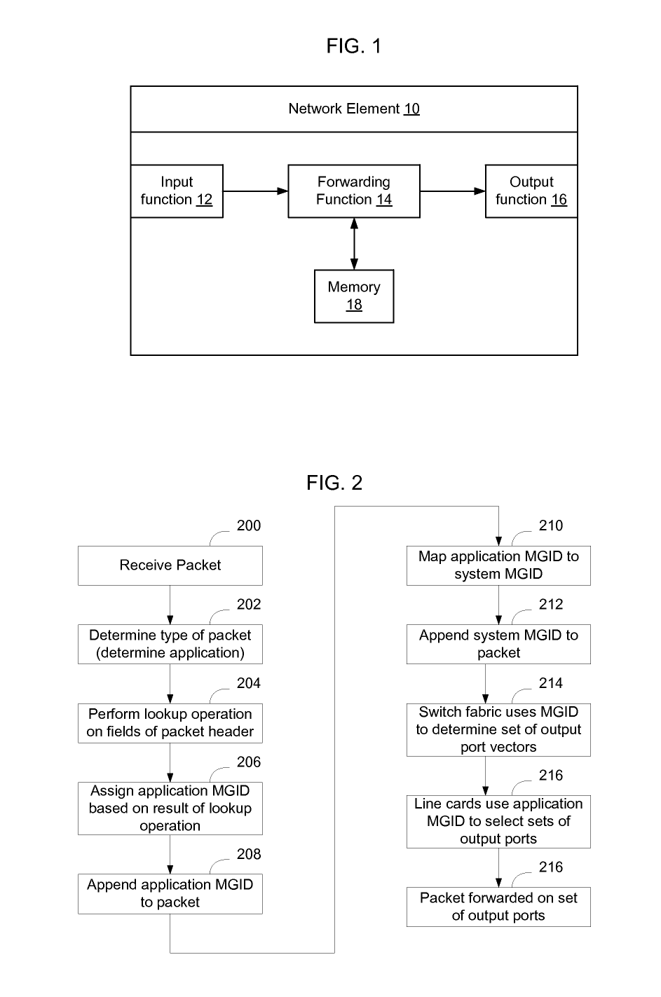

FIG. 1 is a functional block diagram of an example network element. As shown in FIG. 1, in its simplest form, a network element includes an input function 12 to receive packets of data from a communication network, a forwarding function 14 to make forwarding decisions, and an output function 16 to forward the packet onward onto the communication network. The forwarding function performs lookup operations in memory 18 to determine a set of output ports/interfaces that are to output the packet on the network and causes the packet to be directed to the correct set of output ports/interfaces implemented by output function 16. In one embodiment, the forwarding function 14 includes a switch fabric that uses MGIDs to cause packets to be directed to the correct set of output ports/interfaces implemented by output function 16.

FIG. 2 is a flow diagram of a process that may be implemented in connection with MGID management in a network element such as the network element of FIG. 1. As shown in FIG. 2, when a packet is received (200) the network element will determine the type of packet to determine which application is to be used to process the packet (202). For example, the network element may determine that the packet has an IP header containing an IPv4 address, an IP header containing an IPv6 address, that the packet has an Ethernet or other layer 2 header, etc. The network element will also perform a lookup operation on one or more fields of the packet header to determine how the network element should handle the packet (204). Numerous processes may be implemented by the network element in connection with determining how a packet should be forwarded. Based on the result of the lookup operation, an application MGID is assigned to the packet (206) from a range of application MGIDs associated with the application.

The applications running on the network element, e.g. IPv4, IPv6, L2, manage application MGIDs which are used, by the application, to specify a set of output ports or port vectors over which a packet, associated with that application and having particular values in the header, should be forwarded. The application manages its own MGID assignment independent of other applications. The MGID values assigned by applications on the network element may be selected from overlapping ranges such that different applications assign the same MGID to packets required to be handled differently by the network element. Each application assigns MGID values independent of other applications and communication of assignments of MGIDs between the applications is not required.

Once an MGID is assigned, it will be appended to the packet (208). Typically this is implemented by attaching an application MGID on top of the header such that the application MGID is encountered first by the network hardware when processing a packet.

A system MGID mapping function maps the application MGID to a system MGID (210) which is also appended to packet 212. The system MGID is used by the switch fabric to cause the packet to be forwarded to a set of port vectors (214). Since the system MGID defines the manner in which the transport occurs within the network element, the mapping function is implemented such that the system MGID selected for an application MGID includes at least all of the ports specified by the application MGID. For example, if the application MGID includes a port vector, the application MGID will be mapped to a system MGID which will cause the packet to be forwarded to a set of egress nodes which contain all of the ports specified by the port vector. Likewise, if the application MGID includes a list of port vectors, the application MGID will be mapped to a system MGID which will cause the packet to be forwarded to a set of egress nodes which contain a superset of all of the ports specified by each of the port vectors.

The system MGID specifies a port vector which identifies, within the network element, a set of line cards, slices of line cards, or other physical entities that should receive a copy of the packet. Each of the line cards that receives a copy of the packet uses the application MGID to determine whether any port on the egress node requires a copy of the packet and, if so, to select a set of ports on that line card over which the packet should be forwarded (216). The output function then forwards the packet on the selected set of output ports onto the network (218).

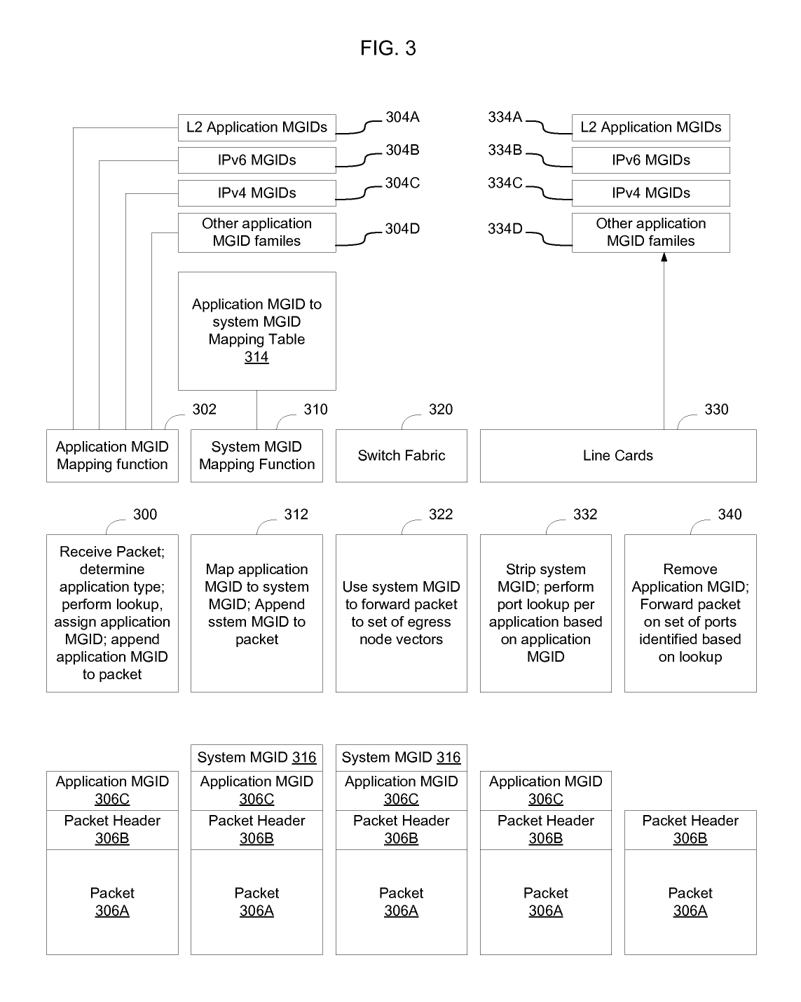

FIG. 3 shows the progression of a packet as it is handled by a network element. The bottom row shows the packet format as it is processed by the network element. The middle row describes the function that is implemented at each processing stage, and the top row shows the hardware elements in the network element that implement the function at the processing stage.

As shown in FIG. 3, when a packet is received, the network element will determine the application type, perform a lookup, assign an application MGID and append the application MGID to the packet 300. An application MGID mapping function 302 is used to implement the mapping and interacts with application specific MGID tables such that application MGIDs are assigned per application from separate application specific MGID tables. In FIG. 3, an example is provided in which the network element has an application specific MGID table for L2 switching 304A, an application specific MGID table for IPv6 304B, an application specific MGID table for IPv4 304C, and a set of other application specific MGID tables for other application MGID families 304D. The packet, at the end of this stage of processing, includes a packet body 306A, a packet header 306B, and an application specific MGID 306C.

A system MGID mapping function 310 in the network element will map the application MGID to a system MGID and append the system MGID to the packet 312. The system MGID mapping function maintains a table 314 correlating application MGIDs to system MGIDs. When an application assigns an MGID, information associated with the application MGID assignment is passed to the system MGID mapping function to enable the system MGID mapping function to update the application MGID to system MGID mapping table 314. For example, when an application assigns an MGID it will specify a set of output ports on the network element over which packets associated with the application MGID should be forwarded. The application will pass the application MGID value along with information identifying the set of output ports to the system MGID mapping function, so that the system MGID mapping function can correlate the application MGID with a system MGID that will cause the switch fabric to forward the packet to a port vector inclusive of all required ports. As a result of the mapping, a system MGID 316 is assigned to the packet and appended to the packet.

The system MGID is an egress node vector which specifies a set of egress nodes that should receive a copy of the packet. The switch fabric 320 uses the system MGID to replicate the packet as necessary and forward the packet to the set of egress nodes specified by the egress node vector associated with the system MGID 322. The egress nodes may be implemented as line cards, slices of line cards, or other physical hardware entities. For simplicity, an example will be described in which line cards are used to implement the functions of the egress nodes. In other embodiments other physical or logical hardware entities may be used instead of line cards.

Once the switch fabric has forwarded the packet to the set of egress nodes, the system MGID is no longer required and may be removed from the packet. This may be done by the switch fabric or by the egress node depending on the implementation.

When a line card 330 or other egress node on the network element receives a packet, it will strip the system MGID off the packet (if not previously removed by the switch fabric), and use the application MGID to perform a port lookup based on the application MGID 332. Each line card includes a set of per-application MGID tables 334A-D correlating application MGIDs with sets of output ports on the line card over which packets associated with the application MGID should be forwarded. In one embodiment, prior to performing an application MGID lookup, the egress node may implement a lookup in a set of per-application pruning tables to determine if any ports on the egress node require a copy of the packet prior to performing a search to determine the identity of the ports. This allows the egress node to quickly determine which packets may be dropped to minimize the number of application MGID lookups in the application MGID forwarding tables.

The line card per-application MGID tables 334A-D may be created/updated by the system MGID mapping function as application MGIDs are inserted into the application MGID to system MGID mapping table 314. For example, when the system MGID mapping function receives an application MGID assignment and associated port information, it may insert information into the line card per-application MGID tables 334A-D to enable the line cards to implement an application MGID lookup upon receipt of a packet. Alternatively, the application MGID mapping function 302 may cause this information to be populated in connection with assigning the application MGID.

In one embodiment, the line card per-application MGID tables only include information about ports associated with the particular line card. Thus, for example, if a particular application MGID requires a packet to be forwarded on ports 1 and 2 implemented by a first line card, and requires the packet to be forwarded on ports 3 and 4 implemented by a second line card, the line card per-application MGID table on the first line card will only contain an association between the application MGID and ports 1 and 2. The fact that the packet is also required on ports 3 and 4 is irrelevant to the first line card and, accordingly, is not included in the line card per-application MGID table on the first line card. This allows the line card per-application MGID table to be smaller than the application MGID tables maintained by the application MGID Mapping function.

Likewise, in one embodiment, the line-card per-application MGID tables only include entries for application MGIDs when there is at least one port on the line card over which a packet should be forwarded. In this embodiment, if a line card receives a packet and there is no entry in the line-card per-application MGID table for that application, the line card will drop the packet. This allows a smaller set of system MGIDs to be used by allowing the switch fabric to be overly inclusive when forwarding packets to sets of output nodes. Specifically, the switch fabric is able to forward a packet to an overly inclusive set of line cards with the understanding that the line cards will simply drop the packet if they do not have any output ports on which to forward the packet. Use of per-application pruning tables also facilitates this feature by allowing the egress nodes to determine whether a packet should be dropped prior to performing an application MGID lookup in the per-application MGID table.

Once the line card has determined a set of output ports, the application MGID will be removed from the packet and the packet will be forwarded onto the network 340.

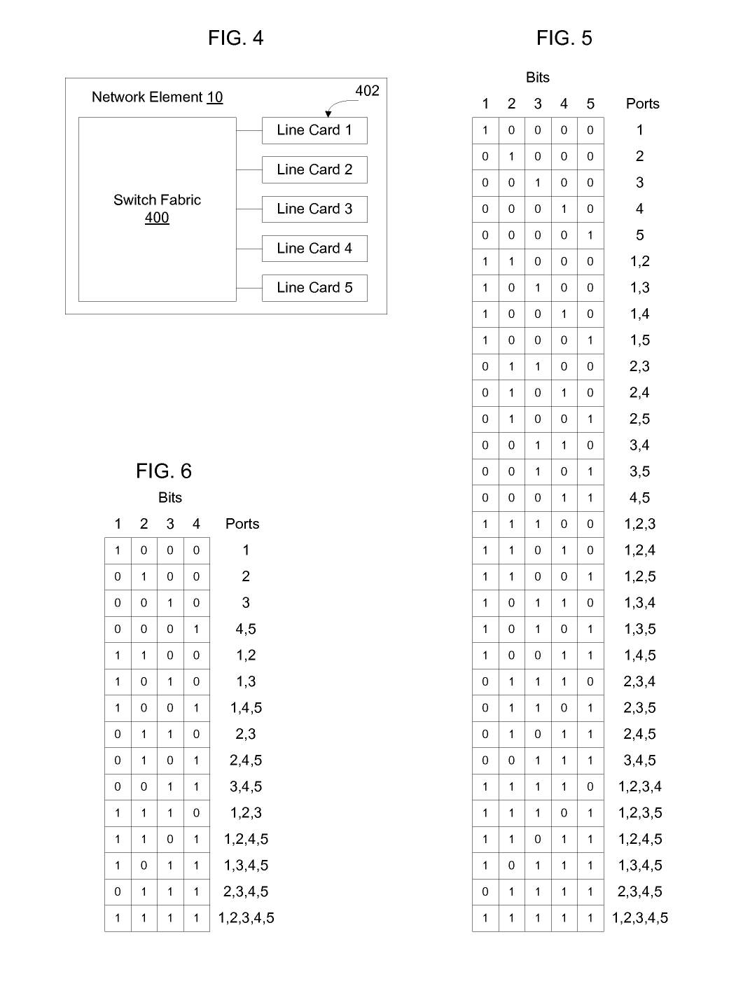

FIG. 4 shows an example switch fabric 400 and a set of line cards 402. The line cards are numbered from 1 through 5 in this example. FIG. 5 shows an associated set of system MGIDs that will allow the switch fabric to forward a packet to sets of line cards 402. In the example shown in FIG. 5, the system MGIDs are 5 bits long and are implemented as a bit vector, such that each bit is associated with one of the line cards 402. A bit has a value 1 in the bit vector if the switch fabric is to forward a copy of the packet to the line card and has a value of 0 in the bit vector if the switch fabric is not to forward a copy of the packet to the line card. Thus, for example, bit vector [1 0 1 0 1] indicates that line cards 1, 3, and 5 should receive a copy of the packet and that line cards 2 and 4 should not receive a copy of the packet. The set of system MGIDs shown in FIG. 5 is intended to have a full set of MGIDs, such that each possible combination of line cards is uniquely specified by one of the MGIDs. Although a bit vector is used in this example, alternatively a binary function may be used to correlate sets of output ports with MGIDs.

Where the number of line cards is large, the number of possible unique combinations of line cards may exceed the number of system MGIDs. For example, if the system shown in FIG. 4 was only able to support 16 MGIDs, a reduced set of MGIDs may be used to specify the output ports. For example, as shown in FIG. 6, a 4 bit MGID may be used to specify forwarding rules to line cards 1-5, in which bit #4 in the MGID is used to identify both line card 4 and line card 5. This causes a copy of the packets to be forwarded to both line cards 4 and 5 whenever bit #4 is set, but allows a reduced number of system MGIDs to be used to forward packets to sets of line cards on the network element. For example, in FIG. 6 MGID [1 0 0 1] will cause packets to be sent to line cards 1, 4, and 5.

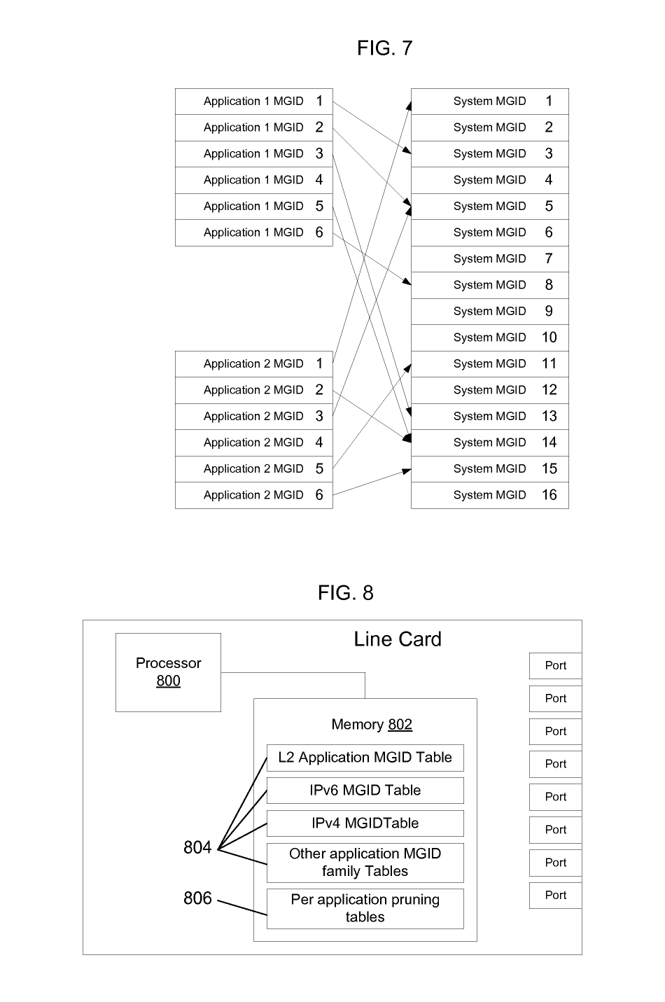

FIG. 7 shows an example mapping between application MGIDs and system MGIDs. As discussed above, the system MGIDs are transport MGIDs associated with sets of output nodes (e.g. line cards) on the network element that should receive a copy of a packet. Application MGIDs, by contrast, are assigned by applications. For example, an application may assign an application MGID per VPN, per multicast, or in some other way. The application is not required to consider the set of output ports to receive the packet or the actual manner in which the network element will transport the packet in connection with implementing the forwarding function when assigning the MGID. The applications do not know which line card carries a particular port on the network element, but rather understand from a logical perspective how a particular packet should be forwarded. Accordingly, the application MGIDs assigned by the applications may be considered to be virtual MGIDs as they enable the underlying transport provided by the system to be abstracted and provided as a service to the applications.

As shown in FIG. 7, each application thus manages its own application MGID space and is allowed to assign application MGIDs to traffic without regard to how other applications are assigning application MGIDs. This provides an advantage to the applications, by decoupling application MGID assignment from each other. Further, since the application MGIDs are maintained separately for separate applications, both applications can assign the same MGID value so that applications are not required to allocate MGIDs from non-overlapping ranges.

In the example shown in FIG. 7, application 1 has assigned application 1 MGID #2 to a set of ports which is mapped, by the system MGID mapping function, to system MGID #5. Likewise, application 2 has assigned application 2 MGID #3 to a set of ports which is mapped, by the system MGID mapping function, to system MGID #5. In this example, different applications have assigned application MGIDs which identify groups of ports that are maintained by the same set of line cards. In this instance, the system MGID mapping function will commonly map the separate application MGIDs to a common system MGID. The system MGID will then be used by the switch fabric to forward the packet to the set of line cards identified by the system MGID. Since the application MGIDs map to a confined set of system MGIDs, potentially an unlimited number of application MGIDs may be specified by the applications. These application MGIDs are then mapped to the system MGIDs which provide transport services across the switch fabric to a set of egress nodes inclusive of all output ports specified by the application MGIDs.

FIG. 8 shows a functional block diagram of an example line card. As shown in FIG. 8, the line card includes a processor 800 and a memory 802. Memory 802 includes line-card per-application MGID tables 804 which, in this example, are shown as including an L2 application MGID table, an IPv6 MGID table, an IPv4 MGID table, and other application MGID family tables. Line card further includes per-application pruning tables which indicate whether the egress node has any ports for a given application MGID. When a packet is received at the line card, the per-application pruning table is consulted to determine whether the line card has any ports that require a copy of the packet. This enables the line card to drop packets prior to performing a port lookup where no ports on the line card require a copy of the packet. If the per-application pruning table indicates that at least one or more ports on the line card require a copy of the packet, a lookup is performed in the line-card per-application MGID tables to determine a set of output ports based on the application MGID carried on the packet. A copy of the packet is then sent to each of the ports identified by the lookup to enable the set of ports to forward the packet on the network.

The functions described herein may be embodied as a software program implemented in control logic on a processor on the network element or may be configured as a FPGA or other processing unit on the network element. The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible non-transitory computer-readable medium such as a random access memory, cache memory, read-only memory chip, a computer memory, a disk, or other storage medium. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of forwarding packet in a network element utilizing multicast group IDs (MGID), the method comprising the steps of:
assigning an application MGID to a packet based on information in the packet header;
mapping the application MGID to a system MGID;
using the system MGID by the network element to identify a set of egress nodes to receive a copy of the packet; and
using the application MGID by each of the egress nodes that receives a copy of the packet to determine a set of output ports on that output node to receive a copy of the packet.

2. The method of claim 1, further comprising the steps of appending the application MGID to the packet, and appending the system MGID to the packet.

3. The method of claim 2, wherein the system MGID is read by a switch fabric of the network element to identify the set of egress nodes to receive the copy of the packet.

4. The method of claim 2, wherein the application MGID is read by each of the egress nodes that receives a copy of the packet to determine the set of output ports on that node to receive a copy of the packet.

5. The method of claim 2, wherein the application MGID used by the egress nodes to determine whether any node on the egress node is required to receive a copy of the packet.

6. The method of claim 1, wherein the step of mapping causes a correlation between application MGID and system MGID such that the set of egress nodes identified by the system MGID includes egress nodes containing ports inclusive of all ports specified by the application MGID.

7. The method of claim 1, wherein the application MGID specifies a port vector; and wherein the step of mapping causes selection of a system MGID containing a node vector specifying nodes containing each of the ports specified in the port vector.

8. The method of claim 1, wherein the application MGID specifies a list of port vectors; and wherein the step of mapping causes selection of a system MGID containing a node vector specifying nodes containing a superset of all ports specified by the list of port vectors.

9. The method of claim 1, wherein the step of assigning an application MGID based on information in the packet header comprises the steps of receiving a packet, determining an application type, performing a lookup operation on one or more fields of the packet header, and assigning the application MGID based on the result of the lookup operation.

10. A network element, comprising:
an application MGID mapping function correlating packets with application MGIDs;
an application MGID to system MGID mapping table;
a switch fabric configured to use system MGIDs to make forwarding decisions for packets of data handled by the network element; and
a set of egress nodes;
wherein the switch fabric forwards packets of data handled by the network element to sets of egress nodes specified by the system MGIDs; and
wherein the egress nodes use the application MGIDs to determine sets of output ports to receive copies of the packets of data.

11. The network element of claim 10, wherein the application MGID mapping function is specific to each application such that each application assigns application MGIDs independent of how other applications assign application MGIDs.

12. The network element of claim 11, wherein multiple applications assign the same application MGID to identify different sets of output ports on the network element.

13. The network element of claim 10, wherein the application MGID to system MGID mapping function determines a system MGID for the application MGID which includes a set of egress nodes hosting all ports associated with the application MGID.

14. The network element of claim 10, wherein the egress nodes are line cards, and wherein the system MGID specifies a set of line cards to receive a copy of the packet.

15. The network element of claim 14, wherein each line card maintains a set of per-application pruning tables.

16. The network element of claim 15, wherein the line cards use the per-application pruning tables to identify packets that should be dropped.

17. A method of forwarding packets in a network element, the method comprising the steps of:
assigning application MGIDs, each application MGID specifying a port vector or a set of port vectors, the application MGIDs being assigned by multiple applications each of which assigns application MGIDs specific to the application independent of the other applications;
mapping application MGIDs to system MGIDs such that the system MGID includes an egress node vector containing a set of nodes responsible for ports inclusive of all ports associated with the application MGID; and
transporting packets of data through the network element using the system MGIDs.
